(19) United States
(12) Patent Application Publication
(10) Pub. No.: US 2019/0054575 A1
(43) Pub. Date: Feb. 21, 2019

(54) LEAD-FREE SOLDER COMPOSITION

(71) Applicants: HYUNDAI MOTOR COMPANY, Seoul (KR); KIA MOTORS CORPORATION, Seoul (KR); HEESUNG MATERIAL LTD., Yongin-si (KR)

(72) Inventors: Jeejung KIM, Yongin-si (KR); Hyun Chae JUNG, Osan-si (KR); Taekhee PARK, Osan-si (KR); Joo Dong LEE, Seongnam-si (KR)

(21) Appl. No.: 15/792,359

(22) Filed: Oct. 24, 2017

(30) Foreign Application Priority Data
Aug. 17, 2017 (KR) 10-2017-0104273

(51) Int. Cl. B23K 35/26; C22C 13/02

(52) U.S. Cl. CPC B23K 35/262; C22C 13/02

(57) ABSTRACT

A lead-free solder composition includes, with respect to 100 wt % of a total weight of the lead-free solder composition, silver (Ag) at 0.3 to 3.0 wt %, antimony (Sb) at 0.5 to 3.0 wt %, indium (In) at 0.3 to 3.0 wt %, and tin (Sn) as the remaining portion.

### CROSS-REFERENCE TO RELATED APPLICATION

This application claims priority to and the benefit of Korean Patent Application No. 10-2017-0104273 filed in the Korean Intellectual Property Office on Aug. 17, 2017, the entire contents of which are incorporated herein by reference.

### BACKGROUND

### (a) Field

The present disclosure relates to a high strength lead-free solder composition. More particularly, the present disclosure relates to a high strength lead-free solder composition including a four-element-based material of tin (Sn)-silver (Ag)-antimony (Sb)-indium (In).

### (b) Description of the Related Art

In the past, lead was mainly used as a soldering material, but recently it has been prohibited to use lead in electronic products due to environmental regulations, and the use of lead in vehicles is strictly prohibited. Therefore, the conventional lead-based solder materials are being replaced by various kinds of metal alloys. However, a lead-free solder material has lower strength and corrosion resistance than the conventional lead-based alloys, and an ion migration phenomenon therein is easily caused. A Sn—Ag—Cu-based composition, a Sn—Bi-based composition, a Sn—Ag-based composition, and a Sn—Zn—Bi-based composition are used as the typical lead-free solder composition depending on an application range and purpose thereof, and particularly, a Sn—Ag—Cu-based composition is used for the most wide application range and purpose. The Sn—Ag—Cu-based lead-free solder composition is applied to general electronic products, and other elements are added to the Sn—Ag—Cu-based lead-free solder composition for vehicles and products of a level equivalent to the vehicle that require high reliability, i.e., excellent thermal fatigue characteristics. After soldering with a Sn—Ag—Cu-based lead-free solder composition, when a temperature is extremely repeatedly changed, cracks are generated at the soldered portion due to stress caused by the difference between thermal expansion coefficients of base materials. When the cracks are generated, bonding strength is lowered, thus reliability of the product may be degraded. The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide a lead-free solder composition that has excellent wettability, workability, and thermal fatigue characteristics.

In addition, the present disclosure has been made in an effort to provide a lead-free solder composition that is harmless to the human body and is environmentally friendly.

Further, the present disclosure has been made in an effort to provide a lead-free solder composition that may be applied to electronic products and vehicles.

An exemplary embodiment of the present disclosure provides a lead-free solder composition including, with respect to 100 wt % of a total weight of the lead-free solder composition, silver (Ag) at 0.3 to 3.0 wt %, antimony (Sb) at 0.5 to 3.0 wt %, indium (In) at 0.3 to 3.0 wt %, and tin (Sn) as the remaining portion.

The lead-free solder composition may further include at least one of scandium (Sc), nickel (Ni), chromium (Cr), and cobalt (Co).

The scandium (Sc) at 0.001 to 0.5 wt % may be additionally included.

The nickel (Ni) at 0.001 to 0.05 wt % may be additionally included.

The chromium (Cr) at 0.001 to 0.05 wt % may be additionally included.

The cobalt (Co) at 0.001 to 0.05 wt % may be additionally included.

The silver (Ag) may be at 0.5 to 2.0 wt %.

The silver (Ag) may be at 1.0 to 1.5 wt %.

The antimony (Sb) may be at 0.7 to 2.5 wt %.

The antimony (Sb) may be at 0.7 to 2.5 wt %.

The indium (In) may be at 0.4 to 1.5 wt %.

The indium (In) may be at 0.4 to 1.5 wt %.

When tensile strength is evaluated with the ASTM A370 standard, the lead-free solder composition may have tensile strength of 55 MPa or more.

A thickness increase ratio of an intermetallic compound layer after soldering the lead-free solder composition may be 40% or less after repeating 2000 cycles of a thermal fatigue test in which one cycle is 125° C./30 minutes to −40° C./30 minutes.

A lead-free solder alloy according to an exemplary embodiment of the present disclosure may be manufactured with the above-described lead-free solder composition.

An electronic part according to an exemplary embodiment of the present disclosure may include the above-described lead-free solder alloy.

A vehicle according to an exemplary embodiment of the present disclosure may include the above-described lead-free solder alloy.

According to the exemplary embodiment of the present disclosure, it is possible to provide a lead-free solder composition having excellent wettability, workability, and thermal fatigue characteristics. It is also possible to simultaneously reduce a silver (Ag) content.

In addition, the lead-free solder composition according to the exemplary embodiment of the present disclosure may be applied to vehicles, electronic products, and particularly, to microelectronics, as a solder alloy.

### DETAILED DESCRIPTION

The advantages and features of the present disclosure and the methods for accomplishing the same will be apparent from the exemplary embodiments described hereinafter with reference to the accompanying drawings. However, the present disclosure is not limited to the exemplary embodiments described hereinafter, and may be embodied in many different forms. The following exemplary embodiments are provided to make the present disclosure complete and to allow those skilled in the art to clearly understand the scope of the present disclosure, and the present disclosure is defined only by the scope of the appended claims. Throughout the specification, the same reference numerals denote the same constituent elements.

In some exemplary embodiments, detailed description of well-known technologies will be omitted to prevent the present disclosure from being interpreted ambiguously. Unless otherwise defined, all terms (including technical and scientific terms) used herein have the same meaning as commonly understood by one of ordinary skill in the art. In addition, throughout the specification, unless explicitly described to the contrary, the word “comprise” and variations such as “comprises” or “comprising” will be understood to imply the inclusion of stated elements but not the exclusion of any other elements. Further, as used herein, the singular forms “a”, “an”, and “the” are intended to include the plural forms as well, unless the context clearly indicates otherwise.

In exemplary embodiments of the present disclosure, a weight percent (wt %) is represented as a percentage of a weight of a corresponding composition to a weight of a total composition. Further, in exemplary embodiments of the present disclosure, inclusion of an additional element means replacing the remaining tin (Sn) by an additional amount of the additional elements.

A lead-free solder composition according to an exemplary embodiment of the present disclosure is an eco-friendly and non-toxic solder composition without lead (Pb). According to the exemplary embodiment of the present disclosure, by using a four-element-based material of tin (Sn)-silver (Ag)-antimony (Sb)-indium (In), excellent thermal fatigue characteristics is ensured in a thermal fatigue (thermal shock or thermal cycling) test.

The lead-free solder composition according to the exemplary embodiment of the present disclosure is designed in consideration of wettability and workability during soldering and of reliability for a thermal fatigue (thermal shock or thermal cycling) test, and has excellent quality compared to a conventional lead-free solder composition.

The lead-free solder composition according to the exemplary embodiment of the present disclosure contains silver (Ag), antimony (Sb), indium (In), and tin (Sn). Hereinafter, each component will be described in detail.

The lead-free solder composition according to the exemplary embodiment of the present disclosure includes silver (Ag) at 0.3 to 3.0 wt % based on a total weight thereof. Specifically, it may include the silver (Ag) at 0.5 to 2.0 wt %, and more specifically, it may include the silver (Ag) at 1.0 to 1.5 wt %. An intermetallic compound of Sn—Ag having a dense needle-shaped structure generated during soldering within the above-mentioned range increases strength of a solder alloy. In addition, elongation is improved to enhance the thermal fatigue characteristics and dropping resistance.

The lead-free solder composition according to the exemplary embodiment of the present disclosure includes antimony (Sb) at 0.5 to 3.0 wt % based on a total weight thereof. Specifically, it may include the antimony (Sb) at 0.7 to 2.5 wt %, and more specifically, it may include the antimony (Sb) at 1.5 to 2.0 wt %. When it is included in the above-mentioned range, it is possible to secure the thermal fatigue characteristics by having resistance from shear stress during a thermal fatigue (thermal shock or thermal cycling) test and reducing the crack initiation speed and expansion range, and this is maximized according to uniformly diffusing an antimony (Sb) material.

The lead-free solder composition according to the exemplary embodiment of the present disclosure includes indium (In) at 0.3 to 3.0 wt % based on a total weight thereof. Specifically, it may include the indium (In) at 0.4 to 1.5 wt %, and more specifically, it may include the indium at 0.5 to 1.0 wt %. When it is included in the above-mentioned range, it is possible to control a melting point, to ensure excellent bonding strength and wettability, and to maintain strength by absorbing thermal fatigue.

In the lead-free solder composition according to the exemplary embodiment of the present disclosure, Tin (Sn) is included as the remaining portion to satisfy 100 wt % of a total weight thereof. The tin (Sn) is not self-toxic and has excellent solubility with other metals, thereby allowing various alloys to be easily manufactured.

The lead-free solder composition according to the exemplary embodiment of the present disclosure may additionally include at least one of scandium (Sc), nickel (Ni), chromium (Cr), and cobalt (Co).

When the scandium (Sc) is additionally included, it may be included at 0.001 to 0.5 wt % based on a total weight thereof. When it is included in the above-mentioned range, strength and spreadability of the solder may be further improved. However, when the scandium (Sc) is included in too large an amount, since an insoluble compound is generated, workability may deteriorate. When the scandium (Sc) is included in too small an amount, strength improvement and spreadability improvement may be insignificant.

When the nickel (Ni) is additionally included, it may be included at 0.001 to 0.05 wt % based on a total weight thereof. When it is included in the above-mentioned range, it is possible to effectively secure strength by reducing a thickness of an intermetallic compound. When the nickel (Ni) is included in too large an amount, wettability may be deteriorated. When the nickel (Ni) is included in too small an amount, strength improvement may be insignificant.

When the chromium (Cr) is additionally included, it may be included at 0.001 to 0.05 wt % based on a total weight thereof. When it is included in the above-mentioned range, it is advantageous for anti-corrosion, drop impact, and strength improvement. When the chromium (Cr) is included in too large an amount, workability may be deteriorated. When the chromium (Cr) is included in too small an amount, anti-corrosion, drop impact, and strength improvement may be insignificant.

When the cobalt (Co) is additionally included, it may be included at 0.001 to 0.05 wt % based on a total weight thereof. When it is included in the above-mentioned range, metal diffusion during thermal fatigue is suppressed to improve strength maintenance, and growth of an intermetallic compound layer (IMC layer) may be further suppressed. When the cobalt (Co) is included in too large an amount, workability may be deteriorated. When the cobalt (Co) is included in too small an amount, the above-mentioned effect may be insignificant.

According to the exemplary embodiment of the present disclosure, by applying the four-element-based material of tin (Sn)-silver (Ag)-antimony (Sb)-indium (In), it is possible to obtain a lead-free solder composition having excellent strength. Specifically, when tensile strength thereof is evaluated by the ASTM A370 standard, the tensile strength may be 55 MPa or more. Since the ASTM A370 standard is well known, a detailed description thereof will be omitted.

Since the four-element-based material of tin (Sn)-silver (Ag)-antimony (Sb)-indium (In) is applied to the lead-free solder composition according to the exemplary embodiment of the present disclosure, the thermal fatigue characteristics thereof are excellent. This is because it is possible to suppress formation of a tight intermetallic compound layer (IMC layer) and thickness increase. The intermetallic compound layer including Ag₃Sn has a tight needle-shaped structure and may secure an excellent initial strength value. In addition, since a decrease of shear stress due to the addition of Sb and an increase of ductility due to the addition of In increase resistance of a bonding portion with respect to an environmental test to maintain strength and to suppress growth of the intermetallic compound layer (IMC), it is advantageous to maintain an initial strength regardless of a use period.

In the lead-free solder composition according to the exemplary embodiment of the present disclosure, since the growth of the intermetallic compound layer is maximally suppressed, the thermal fatigue characteristics are improved. Specifically, regarding a thickness of the intermetallic compound layer after soldering the lead-free solder composition, after 2000-cycle repetition of the thermal fatigue test for 30 minutes (one cycle corresponds to 125° C. to −40° C.), a thickness increase rate of the intermetallic compound layer may be 40% or less. Specifically, it may be 35% or less.

The lead-free solder composition according to the exemplary embodiment of the present disclosure may be applied to at least one solder product of a solder paste, a solder ball, a solder bar, a solder wire, a solder bump, a solder plate, a solder powder, a solder ribbon, and a solder ring.

The lead-free solder composition according to the exemplary embodiment of the present disclosure may be manufactured of a lead-free solder alloy, and the lead-free solder alloy may be usefully used in electronic parts and vehicles.

Hereinafter, examples of the present disclosure and comparative examples will be described in detail. However, the following examples are for exemplary purposes only, and the scope of the present disclosure is not limited thereto.

### Examples 1 to 8 and Comparative Examples 1 to 14: Manufacturing of Lead-Free Solder Compositions

Lead-free solder compositions according to Examples 1 to 8 and Comparative Examples 1 to 14 were manufactured with compositions shown in Table 1.

TABLE 1

| | Silver | Antimony | Indium | Others | Tin |
|---|---|---|---|---|---|
| Classification | (wt %) | (wt %) | (wt %) | (wt %) | (wt %) |
| Comparative Example 1 | — | — | — | — | 100 |
| Comparative Example 2 | 3.0 | — | 0.5 | — | Remaining amount |
| Comparative Example 3 | 0.3 | — | 0.7 | — | Remaining amount |
| Comparative Example 4 | — | — | — | Ni: 0.01 | Remaining amount |
| Comparative Example 5 | — | — | — | Cr: 0.01 | Remaining amount |
| Comparative Example 6 | — | — | — | Co: 0.01 | Remaining amount |
| Comparative Example 7 | — | — | — | Sc: 0.01 | Remaining amount |
| Comparative Example 8 | — | — | — | Sc: 0.005 | Remaining amount |
| Comparative Example 9 | 0.5 | — | — | Sc: 0.005 | Remaining amount |
| Comparative Example 10 | 1.5 | — | — | Sc: 0.005 | Remaining amount |
| Comparative Example 11 | 1.5 | — | 0.5 | Sc: 0.005 | Remaining amount |
| Comparative Example 12 | 1.5 | — | 1.0 | Sc: 0.005 | Remaining amount |
| Comparative Example 13 | — | 1 | 1.0 | Sc: 0.005 | Remaining amount |
| Comparative Example 14 | — | 2 | 1.0 | Sc: 0.005 | Remaining amount |
| Example 1 | 1.5 | 2 | 1.0 | Sc: 0.005 | Remaining amount |
| Example 2 | 1.5 | 1 | 1.0 | Sc: 0.005 | Remaining amount |
| Example 3 | 1.5 | 2 | 0.5 | Sc: 0.005 | Remaining amount |
| Example 4 | 1.0 | 2 | 1.0 | Sc: 0.005 | Remaining amount |
| Example 5 | 1.0 | 1 | 0.5 | Sc: 0.005 | Remaining amount |
| Example 6 | 1.5 | 1 | 1.0 | Ni: 0.005 | Remaining amount |
| Example 7 | 1.5 | 1 | 1.0 | Cr: 0.005 | Remaining amount |
| Example 8 | 1.5 | 1 | 1.0 | Co: 0.005 | Remaining amount |

Tensile strengths of the solder alloys prepared with the lead-free solder compositions of Examples 1 to 8 and Comparative Examples 1 to 14 were evaluated. The metal tensile strength was evaluated by the ASTM A370 standard. The evaluated results are shown in Table 2.

TABLE 2

| Classification | Metal tensile strength (MPa) |
|---|---|
| Comparative Example 1 | 24 |
| Comparative Example 2 | 49 |
| Comparative Example 3 | 34 |
| Comparative Example 4 | 37 |
| Comparative Example 5 | 35 |
| Comparative Example 6 | 38 |
| Comparative Example 7 | 41 |
| Comparative Example 8 | 42 |
| Comparative Example 9 | 44 |
| Comparative Example 10 | 51 |
| Comparative Example 11 | 50 |
| Comparative Example 12 | 52 |
| Comparative Example 13 | 54 |
| Comparative Example 14 | 58 |
| Example 1 | 61 |
| Example 2 | 57 |
| Example 3 | 60 |
| Example 4 | 56 |
| Example 5 | 55 |
| Example 6 | 58 |
| Example 7 | 60 |
| Example 8 | 57 |

As shown in Table 2, it can be seen that the intensity of the examples including silver (Ag), antimony (Sb), and indium (In) is substantially improved compared to that of the comparative examples.

### Experimental Example: Characteristic Evaluation of Lead-Free Solder Composition

Characteristics of the solder alloys prepared with the lead-free solder compositions of Examples 1 to 8 and Comparative Examples 1 to 14 were evaluated by the following test methods. After a solder wire was prepared by using an ROL1-class halogen free flux, it was evaluated, and the evaluation results are shown in Table 3.

In Table 3, the spreadability is represented by numerical values, the thermal fatigue (thermal shock or thermal cycling) test is represented by OK or NG according to presence or absence of cracking per respective cycles, and the thickness of the intermetallic compound layer (IMC) layer is represented by numerical values. In addition, the strength reduction ratio is represented by numerical values.

TABLE 3

| | | Cracking due to thermal fatigue | | | | | 2000 cycles | |
|---|---|---|---|---|---|---|---|---|
| | | (thermal shock, thermal cycling) | | | | | IMC layer | Strength |
| | | 0 | 500 | 1000 | 1500 | 2000 | variation | reduction |
| Classification | Spreadability | cycle | cycle | cycle | cycle | cycle | ratio | ratio |
| Comparative | 82.6% | OK | NG | NG | NG | NG | +52% | −51% |
| Example 1 | | | | | | | | |
| Comparative | 81.7% | OK | OK | OK | NG | NG | +41% | −43% |
| Example 2 | | | | | | | | |
| Comparative | 80.2% | OK | OK | NG | NG | NG | +42% | −45% |
| Example 3 | | | | | | | | |
| Comparative | 80.1% | OK | OK | NG | NG | NG | +45% | −48% |
| Example 4 | | | | | | | | |
| Comparative | 80.3% | OK | OK | NG | NG | NG | +44% | −49% |
| Example 5 | | | | | | | | |
| Comparative | 80.1% | OK | OK | NG | NG | NG | +44% | −49% |
| Example 6 | | | | | | | | |
| Comparative | 82.7% | OK | OK | NG | NG | NG | +46% | −48% |
| Example 7 | | | | | | | | |
| Comparative | 82.3% | OK | OK | NG | NG | NG | +45% | −48% |
| Example 8 | | | | | | | | |
| Comparative | 82.9% | OK | OK | OK | NG | NG | +42% | −42% |
| Example 9 | | | | | | | | |
| Comparative | 83.2% | OK | OK | OK | NG | NG | +41% | −34% |
| Example 10 | | | | | | | | |
| Comparative | 82.7% | OK | OK | OK | OK | NG | +33% | −26% |
| Example 11 | | | | | | | | |
| Comparative | 82.2% | OK | OK | OK | OK | NG | +31% | −23% |
| Example 12 | | | | | | | | |
| Comparative | 80.6% | OK | OK | OK | NG | NG | +44% | −20% |
| Example 13 | | | | | | | | |
| Comparative | 80.3% | OK | OK | OK | NG | NG | +41% | −19% |
| Example 14 | | | | | | | | |
| Example 1 | 82.1% | OK | OK | OK | OK | OK | +26% | −14% |
| Example 2 | 81.4% | OK | OK | OK | OK | NG | +30% | −17% |
| Example 3 | 81.1% | OK | OK | OK | OK | NG | +30% | −16% |
| Example 4 | 81.5% | OK | OK | OK | OK | NG | +32% | −19% |
| Example 5 | 81.8% | OK | OK | OK | OK | NG | +32% | −22% |
| Example 6 | 82.2% | OK | OK | OK | OK | OK | +30% | −20% |
| Example 7 | 83.1% | OK | OK | OK | OK | OK | +28% | −15% |
| Example 8 | 82.1% | OK | OK | OK | OK | NG | +35% | −25% |

(1) Spreadability Comparison

The spreadability was measured with a micrometer by heating for 30 seconds at a temperature of +50° C. based on a melting point (liquid phase) for each composition.

Referring to the measured results, as shown in Table 3, it was confirmed that the degree of the spreadability was different depending on the kind and content of added components and that the spreadability of the examples was equal to or much better than that of Comparative Examples 2 and 3 corresponding to the conventional three-element-based composition.

(2) Crack Comparison in Thermal Fatigue (Thermal Shock or Thermal Cycling) Test

After the solder alloy was soldered on an epoxy-hole-processed PCB, the cracks were observed by a thermal shock tester at 125° C. or −40° C. for 500, 1000, 1500, and 2000 cycles (cycle/30 minutes).

Referring to the observed results, as shown in Table 3, it was confirmed that the starting point of crack generation in the four-element-based alloys of the examples was better than that of the comparative examples.

(3) Variation Ratio of Intermetallic Compound Layer (IMC Layer)

After repeating 2000 cycles in the same manner as in the thermal shock cracking test, the thickness variation of the intermetallic compound layers (IMC layers) was confirmed by comparing them with those before the thermal shock cracking test.

Intermetallic compound layer thickness variation (%)=([thickness after thermal shock cracking test]−[thickness before thermal shock cracking test])/[thickness before thermal shock cracking test]

Referring to the results, as shown in Table 3, it was confirmed that the thickness variations of the intermetallic compound layers (IMC layers) of the four-element-based alloys of the examples were smaller than those of the comparative examples.

(4) Strength Reduction Ratio

The strength variation ratios of the specimens evaluated in the same manner as the IMC layer variation ratio test were confirmed. The strength variation varies depending on coarsening of an internal metal structure and occurrence of cracking, and the difference of the strength variation between examples and comparative examples was clearly confirmed. A low strength reduction ratio means that the internal cracks are few, which means that change of electrical resistance is small. Therefore, the strength reduction ratio is an absolute criterion for dividing a high-strength lead-free solder composition and a general lead-free solder.

As compared with the comparative examples, it was confirmed that the strength reduction ratios of the alloys of the examples were remarkably low. As a result, it was concluded that the composition of the examples corresponded to the characteristics of the high strength lead-free solder composition.

As shown in Table 3, it was confirmed that the solder of the examples made of tin-silver-antimony-indium had better spread characteristics and reliability for the thermal fatigue (thermal shock or thermal cycling) test than the solder according to the comparative example, and that sufficient bonding strength was secured.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A lead-free solder composition comprising,
with respect to 100 wt % of a total weight of the lead-free solder composition,
silver (Ag) at 0.3 to 3.0 wt %,
antimony (Sb) at 0.5 to 3.0 wt %,
indium (In) at 0.3 to 3.0 wt %, and
tin (Sn) as the remaining portion.

2. The lead-free solder composition of claim 1, further comprising
at least one of scandium (Sc), nickel (Ni), chromium (Cr), and cobalt (Co).

3. The lead-free solder composition of claim 2, wherein
the scandium (Sc) at 0.001 to 0.5 wt % is additionally included.

4. The lead-free solder composition of claim 2, wherein
the nickel (Ni) at 0.001 to 0.05 wt % is additionally included.

5. The lead-free solder composition of claim 2, wherein
the chromium (Cr) at 0.001 to 0.05 wt % is additionally included.

6. The lead-free solder composition of claim 2, wherein
the cobalt (Co) at 0.001 to 0.05 wt % is additionally included.

7. The lead-free solder composition of claim 1, wherein
the silver (Ag) is at 0.5 to 2.0 wt %.

8. The lead-free solder composition of claim 1, wherein
the antimony (Sb) is at 0.7 to 2.5 wt %.

9. The lead-free solder composition of claim 1, wherein
the indium (In) is at 0.4 to 1.5 wt %.

10. The lead-free solder composition of claim 1, wherein
when tensile strength is evaluated with the ASTM A370 standard, the lead-free solder composition has tensile strength of 55 MPa or more.

11. The lead-free solder composition of claim 1, wherein
a thickness increase ratio of an intermetallic compound layer after soldering the lead-free solder composition is 40% or less after repeating 2000 cycles of a thermal fatigue test in which one cycle is 125° C./30 minutes to −40° C./30 minutes.

12. A lead-free solder alloy manufactured with the lead-free solder composition of claim 1.

13. An electronic part including the lead-free solder alloy of claim 12.

14. A vehicle including the lead-free solder alloy of claim 12.

15. The lead-free solder composition of claim 1, wherein the silver (Ag) is at 1.0 to 1.5 wt %.

16. The lead-free solder composition of claim 1, wherein the antimony (Sb) is at 0.7 to 2.5 wt %.

17. The lead-free solder composition of claim 1, wherein the indium (In) is at 0.4 to 1.5 wt %.
